(19) United States
(12) Patent Application Publication
(10) Pub. No.: US 2004/0221021 A1
(43) Pub. Date: Nov. 4, 2004

(54) High performance managed runtime environment application manager equipped to manage natively targeted applications

(76) Inventor: Jason A. Domer, Banks, OR (US)

Correspondence Address: Al AuYeung, SCHWABE, WILLIAMSON & WYATT, Suites 1600-1900, 1211 SW 5th Ave., Portland, OR, 97204, US

(21) Appl. No.: 10/427,186

(22) Filed: Apr. 30, 2003

(51) Int. Cl. G06F 15/16

(52) U.S. Cl. 709/219

(57) ABSTRACT

A client device is equipped to request a server for a descriptor of an application. The server is equipped to return the requested descriptor, including if applicable, a first locator to a compiled version of the application. In one embodiment, the descriptor also includes a first locator to a portable version of the application. The client device is equipped to retrieve the compiled version, if the first locator is present. In one embodiment, the retrieved compiled version is stored in a non-volatile storage, and executed in-place.

### FIELD OF THE INVENTION

The present invention relates to the field of data processing. More specifically, the present invention is related to improving execution performance on client devices with managed runtime environments.

### BACKGROUND OF THE INVENTION

Advances in microprocessor and related technologies have led to wide spread deployment and adoption of computing devices. Computing powers that used to be available only in very expensive main frame computers requiring conditioned operating environment, are now available in many personal computing devices. Their form factors vary from desktop, laptop, palm sized, and so forth. A number of these computing devices are packaged as “special purpose” devices, such set-top boxes, entertainment control centers, personal digital assistants (PDA), pagers, text messengers, and wireless mobile phones.

Concurrently, advances in networking, telecommunication and related technologies have led to increased connectivity between computing devices, over local, private, wide area, and/or public networks. Of particular notoriety is the Internet.

Together, these and other related factors have contributed to the popularity of client/server based applications. Of particular notoriety is the World Wide Web (WWW), where increasingly rich multi-media contents may be served from web servers to client devices, with the client devices using a generic agent, such as a browser.

To increase the ease of content creation and/or provision, various application development tools and execution supports, in particular, for the development and execution of portable applications, have become available. Examples of these application tools and execution supports include but are not limited to the Java and Net platforms.

Typically, portable applications are just-in-time compiled on the client devices prior to their execution, after they've been provided (e.g. download) to the client devices. The native execution resources, services and peculiarities are abstracted/shielded from the portable applications/applets by the virtual machines and/or MRTE.

While employment of portable application programming tools for development, and reliance on managed execution runtime environment support generally improve the productivity of application developers, the improvements often come at the expense of execution performance. As described earlier, the downloaded or otherwise provided applications have to be just-in-time compiled prior to execution, and virtual machines often do not fully exploit the total native execution capabilities.

Thus, it is desirable to provide the benefits of portable application development, but without having to enjoy the benefits at significant cost to execution performance.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system view of an example computing environment suitable for use to practice the present invention, in accordance with one embodiment;

FIG. 2 illustrates an architectural view of a client device of FIG. 1 in further detail, in accordance with one embodiment; and

FIG. 3 illustrates the protocol and methods for practicing the present invention, in accordance with one embodiment.

### DETAILED DESCRIPTION OF EMBODIMENTS OF THE INVENTION

The present invention includes techniques to improve application execution performance on client devices with MRTE.

Parts of the description will be presented in terms commonly employed by those skilled in the art to convey the substance of their work to others skilled in the art. From the perspective of the present invention, the terms “application” and “applet” are interchangeable, unless the context clearly indicates to the contrary.

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will be apparent to one skilled in the art that the present invention may be practiced without the specific details. In other instances, well-known features are omitted or simplified in order not to obscure the present invention.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

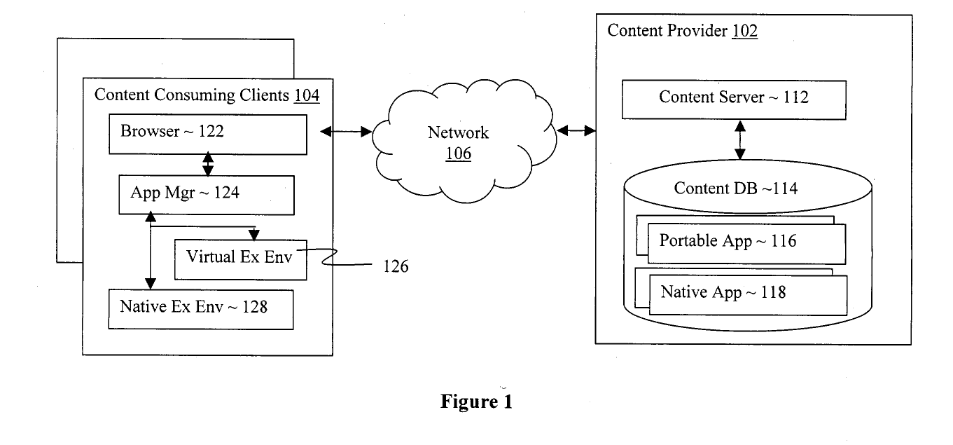

Referring now to FIG. 1, wherein an overview of an example computing environment incorporated with the teachings the present invention, in accordance with one embodiment, is shown. As illustrated, example computing environment 100 includes content provider 102 and content consuming clients 104 coupled to each other via network 106.

For the embodiment, content provider 102 includes content server 112 and content database 114. Content server 112 is employed to provide content, including applications/applets (hereinafter, simply applets), in response to requests of content consuming clients 104. In one embodiment, content server 112 is a web server, equipped to service content requests expressed in accordance with e.g. the Hypertext Transmission Protocol (HTTP). A HTTP request may be transmitted from a client device 104 to content provider 102 via network 106 in accordance with the Transmission Control Protocol/Internet Protocol (TCP/IP).

Content database 114 is employed to store contents. In one embodiment, content database 114 may be a Structured Query Language (SQL) database. In accordance with the present invention, data stored in content database 114 include but are not limited to portable and native versions of applets 116 and 118.

The portable version of an applet is a version to be provided to, and just-in-time compiled on a client device 104, prior to its execution on the client device 104. The execution of a portable version of an applet 116 is typically supported by a corresponding suitable MRTE, possibly including e.g. Java virtual machine 126.

A native version of an application 118 is a compiled version of the application, pre-compiled for a target native execution environment 128. An application may have one or more native versions, with one native version, pre-compiled for one target native execution environment, and another, pre-compiled for another target native execution environment.

In other words, as will be described in more detail below, in accordance with the present invention, for one or more applications, at least two versions of the one or more applications are maintained, a portable version 116 and a native version 118, precompiled for a target native execution environment.

The number of applications having native versions 118, and the number of native versions 118 for each application with at least one native version 118, are both implementation dependent, and are not essential to the practice of the present invention.

In various embodiments, content provider 102 may be a portal, such as Yahoo, a search engine, such as Google, an information service, such as MSNBC, an ecommerce site, such as Amazon.com, or a hybrid, such as an airline's web site. These are just a few example of content provider 102. The present invention does not contemplate any limitation on the nature of the contents or more specifically, applications 116/118, that may be offered to clients 104 by provider 102.

Moreover, the illustration of a single content provider 102 is merely for ease of understanding. The present invention may be practiced concurrently with any number of content providers, subject only to the demand or interest in the contents being provided, the ability of clients 104 to consume the offered content, and bandwidth available over network 106.

Still, referring to FIG. 1, a content consuming content 104 may include e.g. browser 122, an application manager 124, a virtual execution environment 126 and a native execution environment 128, operationally coupled to each other as shown.

Browser 122 is employed to access contents provided by content provider 102, including applications 116/118. An example of a suitable browser is the micro-browser available from e.g. Open Wave of London, UK.

Application Manager 124 is employed to manage the request and launching of applications, including in particular, communication with virtual execution environment 126. As described earlier, virtual execution environment 126 provides abstraction of the native execution services, including shielding of their peculiarities from applications 116. An example of application manager 124 is the Java Application Manager (JAM) of the Java 2 Platform, Micro Edition (J2ME). An example of virtual execution environment 126 is the J2ME CLDC (Connected Limited Device Configuration).

Native execution environment 128 provides native execution supports, including but are not limited to tasks and native resource management, such as memory allocation management. An example of native execution environment 128 is Symbian execution environment, available from Symbian, Inc. of London, UK.

As will be described in more detail below, application manager 124 and content server 124 are complementarily incorporated with the teachings of the present invention, to allow clients 104 to be notified of the availability of native applications 118, when it is appropriate to do so. Resultantly, clients 104 may retrieve and execute native versions 118 in lieu of portable versions 116 of the applications offered by content provider 102.

Except for the teachings of the present invention incorporated with application manager 124 and content server 124, content provider 102 and content consuming clients 104, including the various enumerated elements, otherwise represent a broad range of these elements known in the art. The functions as well as their constitutions are known; accordingly, they will not be further described.

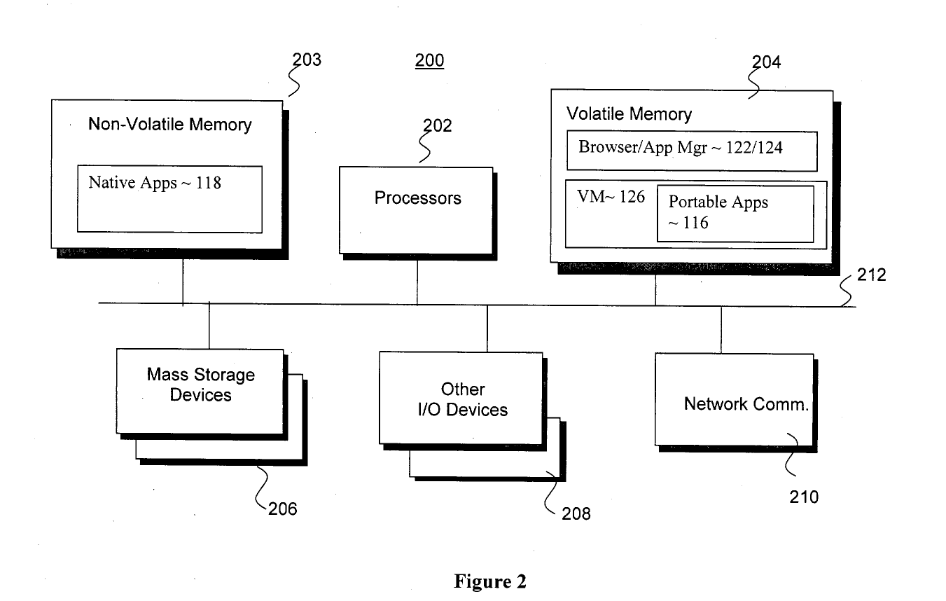

FIG. 2 illustrates an example computing device, suitable for use as a client device 102 to practice the present invention, in accordance with one embodiment. As illustrated, computing device 200 includes one or more processors 202, non-volatile and volatile memory 203-204, mass storage devices 206, other I/O devices 208 and network communication interface 210, coupled to each other as shown.

Processor 202 is employed to execute the various components, i.e. browser 122, application manager 124 and so forth. Processor 202 may be any one of a number of processors known in the art or to designed. Examples of suitable processors include but are not limited microprocessors available from Intel Corp of Santa Clara, Calif.

Volatile memory 204 is employed to store working copies of browser 122, application manager 124, virtual execution environment (or machine) 126, including any downloaded portable applications 116, for execution by processor 202. Volatile memory 204 may be Dynamic Random Access Memory (DRAM), Synchronous DRAM (SDRAM) or other memory devices of the like.

For the embodiment, non-volatile memory 203, among other uses, is employed to store and facilitate execution-in-place applicable ones of native versions of applications 118. Non-volatile memory 203 may be high performance Flash Memory. In alternate embodiments, without execution-in-place, non-volatile memory 203 may be Electrically Eraseable Programmable Read Only Memory (EEPROM) or other memory devices of the like.

Mass storage devices 206 are employed to persistently store data, including any downloaded content, if applicable. Examples of mass storage devices 206 include but are not limited to hard disks, CDROM/RW, DVD-RW, and so forth.

In alternate embodiments, native versions of applications 118 may be downloaded into mass storage devices 206, and then loaded into volatile memory 204 for execution instead.

Other I/O devices 208 are employed to facilitate other aspects of input/output. Examples of other I/O devices 208 include but are not limited to keypads, cursor control, display and so forth.

Network communication interface 210 is employed to facilitate network communication content provider 102 or other devices. Network communication interface 210 may be wired based or wireless, and it may support any one of a known of networking protocols. Examples of network communication interface 210 include but are not limited to an Ethernet compliant network interface card (NIC), a digital subscriber line (DSL) interface, and so forth.

In various embodiments, client device 200 may be a desktop computer, a laptop computer, a tablet computer, a palm-sized computing device, a PDA, a set-top box, an entertainment center controller, a wireless mobile phone, and so forth.

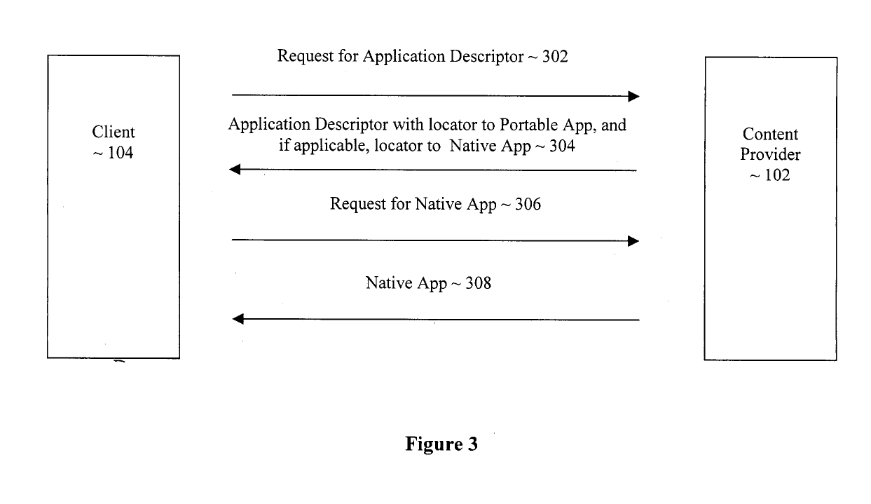

FIG. 3 illustrates the operational logic of the present invention, incorporated in content server 112 and application manager 124, in accordance with one embodiment. As illustrated, in response to a request by enhanced application manager 124, and upon establishing or opening a connection (e.g. a http connection), browser 122 on behalf of client 104 transmits a request for an application descriptor to content provider 102, op 302.

In one embodiment, the request for the application descriptor includes information that allows content provider 102, more specifically, enhanced web server 112, to discern the native execution environment 128 of the requesting client device 104.

In one embodiment, the information is an identifier identifying the processor model or the processor family of the requesting client device 104.

In response, content provider 102, more specifically, enhanced web server 112 replies with the request application descriptor (assuming content provider 102 supports the provision of the requested application which descriptor is being requested), op 304.

In accordance with the present invention, web server 112 conditionally includes a locator identifying a location from where a compiled version 118 of the application pre-compiled for a target native execution environment that is compatible with the native execution environment of the requesting client device 104.

In various embodiments, enhanced web server 112 dynamically determines the native execution environment 128 of the requesting client device 104. In the above described embodiment, enhanced web server 112 makes the determination, based at least in part on the information included with the request for the application descriptor.

In various embodiments, when providing the locator to the location from where the native version 118 of the application may be retrieved, enhanced web server 112 also returns a locator identifying the location from where the portable version 116 of the application may be retrieved.

In other words, for these embodiments, the locator identifying the location from where the portable version 116 of the application may be retrieved is always returned as part of operation 304. For these embodiments, the requesting client device 104 is given a choice to retrieve either the portable 116 or the native version 118 of the application of interest.

In other embodiments, when provided, the locator to the location from where the native version 118 of the application may be retrieved, may be provided exclusively, in lieu of the locator identifying the location from where the portable version 116 of the application may be retrieved. For these embodiments, the requesting client device 104 is not given a choice to retrieve either the portable 116 or the native version 118 of the application of interest.

On receipt, the returned application descriptor is routed to enhanced application manager 124, which has been enhanced to determine whether a returned application descriptor includes a locator to a location from where a native version 118 of the application of interest may be retrieved.

Further, enhanced application manager 124 is also provided with the enhanced logic to request for the native version 118 of the application of interest, on determining that a native version 118 is available (based e.g. at least in part on the presence of the locator in the returned application descriptor), op 306.

In various embodiments, enhanced application manager 124 retrieves the portable version 116, if a native version 118 is not available.

In response to its request, the native version 118 of the application of interest is provided, op 308.

As described earlier, for the embodiment equipped with high performance Flash memory, enhanced application manager 124 is equipped with the logic to store a native version 118 of an application in the non-volatile storage of client device 102, and execute the native version 118 in-place.

However, if it is the portable version 116 that is being retrieved/returned, enhanced application manager 124 stores the provided portable version 116 in mass storage, loads a copy into volatile memory, and transfers execution control to the virtual execution environment 126, which manages/services the execution of the portable version 116 of the application of interest.

Accordingly, under the present invention, while portability is facilitated, native versions 118 of applications may nevertheless be provided and executed to provide improved performance.

### Conclusion and Epilogue

Thus, it can be seen from the above descriptions, a novel technique for conditionally providing native applications/applications has been described.

While the present invention has been described in terms of the foregoing embodiments, those skilled in the art will recognize that the invention is not limited to the embodiments described. The present invention can be practiced with modification and alteration within the spirit and scope of the appended claims.

In particular, the present invention may be practiced with some or all of portable and native versions 116 and 118 of applications being disposed in locations other than content provider 102. In other words, the locators returned by content server 112 identify locations other than itself for the retrieval of the portable/native version 116/118 the applications.

Thus, the description is to be regarded as illustrative instead of restrictive on the present invention.

What is claimed is:

1. In a server, a method of operation comprising:
receiving a request from a client device for a descriptor of an application; and
providing the client device with the requested descriptor of the application, conditionally including with the provided descriptor of the application a first locator to a first location from where a compiled version of the application pre-compiled for a target native execution environment can be obtained.

2. The method of claim 1, wherein
the method further comprises determining the client device's native execution environment, and whether the compiled version of the application pre-compiled for the target native execution environment is compatible with the client device's native execution environment; and
the conditional inclusion being performed based at least in part on the result of said determining.

3. The method of claim 2, wherein
said request comprises information indicative of the client device' native execution environment; and
said determining comprises examining said indicative information of said request.

4. The method of claim 3, wherein said indicative information indicates a selected one of a processor model and a processor family.

5. The method of claim 2, wherein the first locator to the first location is included, if the client device's native execution environment is determined to be compatible with the targeted native execution environment of the compiled version of the application.

6. The method of claim 1, wherein the provided descriptor of the application further includes a second locator to a second location from where a portable version of the application to be locally just-in-time compiled on the client device can be obtained.

7. A server comprising:
storage medium having stored therein a plurality of programming instructions designed to facilitate (a) receipt of a request from a client device for a descriptor of an application, and (b) providing the client device in response the requested descriptor of the application, conditionally including with the descriptor a first locator to a first location from where a compiled version of the application pre-compiled for a target native execution environment can be obtained; and
at least one processor coupled to the storage medium to execute the programming instructions.

8. The server of claim 7, wherein the programming instructions are further designed to
determine the client device's native execution environment, and whether the compiled version of the application pre-compiled for the target native execution environment is compatible with the client device's native execution environment; and
the conditional inclusion being performed, based at least in part on the result of said determining.

9. The server of claim 8, wherein
said request comprises information indicative of the client device' native execution environment; and
the programming instructions are designed to perform said determining by examining said indicative information of said request.

10. The server of claim 9, wherein said indicative information indicates a selected one of a processor model and a processor family.

11. The server of claim 8, wherein the programming instructions are designed to include the first locator to the first location, if the client device's native execution environment is determined to be compatible with the targeted native execution environment of the compiled version of the application.

12. The server of claim 7, wherein the descriptor of the application further includes a second locator to a second location from where a portable version of the application to be locally just-in-time compiled on the client device can be obtained.

13. An article of manufacture comprising:
a recordable medium; and
a plurality of programming instructions recorded thereon, the programming instructions are designed to facilitate (a) receipt of a request from a client device for a descriptor of an application, and (b) providing the client device in response, the requested descriptor of the application, conditionally including a first locator to a first location from where a compiled version of the application pre-compiled for a target native execution environment can be obtained.

14. The article of claim 13, wherein the programming instructions are further designed to
determine the client device's native execution environment, and whether the server has a compiled version of the application pre-compiled for a target native execution environment that is compatible with the client device's native execution environment; and
perform said conditional providing, based at least in part on the result of said determining.

15. The article of claim 14, wherein
said request comprises information indicative of the client device' native execution environment; and
the programming instructions are designed to perform said determining by examining said indicative information of said request.

16. The article of claim 14, wherein the programming instructions are designed to include said first locator to said first location, if the client device's native execution environment is determined to be compatible with the targeted native execution environment of the compiled version of the application.

17. In a client device, a method of operation comprising:
requesting a server for a descriptor of an application;
receiving the requested descriptor of the application; and
determining whether the received descriptor contains a first locator identifying a first location from where a compiled version of the application pre-compiled for a target native execution environment can be obtained.

18. The method of claim 17, wherein the method further comprises accessing the first location identified by the first locator to obtain the compiled version of the application if the received descriptor of the application includes the first locator identifying the first location from where the compiled version of the application can be obtained.

19. The method of claim 17, wherein the method further comprises storing the obtained compiled version of the application in a non-volatile storage, and executing the stored compiled version of the application in-place.

20. The method of claim 17, wherein the descriptor of the application further includes a second locator identifying a second location from where a portable version of the application to be locally just-in-time complied can be obtained.

21. The method of claim 20, wherein the method further comprises accessing the second location identified by the second locator to obtain the portable version of the application.

22. A client device comprising:
storage medium having stored therein a plurality of programming instructions designed to facilitate
submission of a request to a server for a descriptor of an application,
receipt of the requested descriptor of the application; and
making a determination on whether the received descriptor contains a first locator identifying a first location from where a compiled version of the application pre-compiled for a target native execution environment can be obtained; and
at least a processor coupled to the storage medium to execute the programming instructions.

23. The client device of claim 22, wherein the programming instructions are further designed to access the first location identified by the first locator to obtain the compiled version of the application if the received descriptor of the application includes the first locator identifying the first location from where the compiled version of the application can be obtained.

24. The client device of claim 23, wherein the storage medium further comprises non-volatile storage, and the programming instructions are further designed to facilitate storage the obtained compiled version of the application in the non-volatile storage, and allowing the stored compiled version of the application to be executed in-place.

25. The client device of claim 22, wherein the client device is a selected one of a desktop computing device, tablet computing device, laptop computing device, palm sized computing device, pocket computing device, personal digital assistant, and a wireless mobile phone.

26. The client device of claim 22, wherein the descriptor of the application further includes a second locator identifying a second location from where a portable version of the application to be locally just-in-time complied can be obtained.

27. The client device of claim 26, wherein the programming instructions are further designed to access the second location identified by the second locator to obtain the portable version of the application.

28. An article of manufacture comprising:
a recordable medium; and
a plurality of programming instructions recorded thereon, the programming instructions being designed to facilitate
submission of a request to a server for a descriptor of an application,
receipt of the requested descriptor of the application, and
making a determination on whether the received descriptor contains a first locator identifying a first location from where a compiled version of the application pre-compiled for a target native execution environment can be obtained.

29. The article of claim 28, wherein the programming instructions are further designed to access the first location identified by the first locator to obtain the compiled version of the application if the received descriptor of the application additionally includes the first locator identifying the first location from where the compiled version of the application can be obtained.

30. The article of claim 29, wherein the programming instructions are further designed to store the obtained compiled version of the application in a non-volatile storage, and allow the stored compiled version of the application to be executed in-place.
